(19) United States
(12) Patent Application Publication
(10) Pub. No.: US 2008/0021617 A1
(43) Pub. Date: Jan. 24, 2008

(54) Method for Actuating a Vehicle Occupant Protection Device in a Vehicle and a Vehicle Occupant Protection System

(75) Inventors: Karl-Heinz Baumann, Bondorf (DE); Michael Fehring, Neuhausen (DE); Rainer Justen, Altdorf (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 11/578,424

(22) PCT Filed: Apr. 13, 2005
(86) PCT No.: PCT/EP05/03857

§ 371 Date: Jul. 3, 2007

(30) Foreign Application Priority Data
Apr. 16, 2004 (DE) 10 2004 018 394.5

(51) Int. Cl. B60R 22/00

(52) U.S. Cl. 701/46; 701/45

(57) ABSTRACT

A vehicle occupant protection system and a method for actuating a vehicle occupant protection device in a vehicle are provided. The distance from an obstacle is sensed, a braking deceleration which is necessary to avoid a collision is determined, and the determined braking deceleration is used to determine whether a predefined event has occurred. When the predefined event occurs, the vehicle occupant protection device is actuated in order to trigger it or to activate it for the purpose of triggering, the necessary braking deceleration being determined or the determined necessary braking deceleration being evaluated for the occurrence of the predefined event, only if a driver of the vehicle has activated a brake activation element in order to initiate a braking operation.

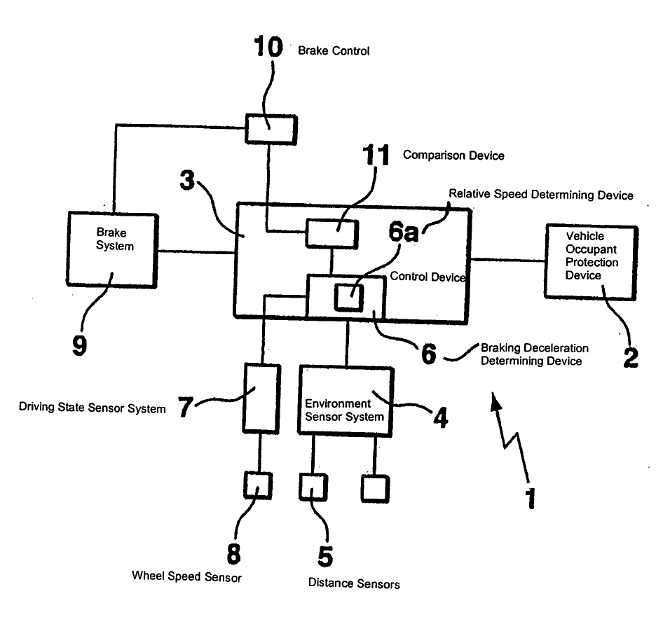

### CROSS REFERENCE TO RELATED APPLICATIONS

This application is a National Phase of PCT International Application No. PCT/EP2005/003857, filed Apr. 13, 2005, which claims priority under 35 U.S.C. § 119 to German Patent Application No. 10 2004 018 394.5 filed Apr. 16, 2004, the entire disclosures of which are herein expressly incorporated by reference.

### BACKGROUND AND SUMMARY OF THE INVENTION

The present invention relates to a method for actuating a vehicle occupant protection device in a vehicle and to a vehicle occupant protection system for carrying out the method.

In addition to a contemporary restraint device such as an airbag and a seatbelt with a seatbelt pretensioner, there are a series of other controllable vehicle occupant protection devices in vehicles which perform a restraining or energy-absorbing function in order to protect a vehicle occupant in the event of a collision. Examples of such vehicle occupant protection devices are displaceable impact elements, cushions and headrests whose size, hardness, shape and position can be changed by an actuation system.

In addition to these vehicle occupant protection devices, it is possible to provide further controllable protection devices for avoiding the severity of an accident. Such, protection devices reduce the consequences of an accident for a vehicle occupant by positioning the vehicle occupant. In other words, the vehicle occupant is moved into a position which is favorable in terms of an accident. The vehicle occupant may be positioned, for example, by an electric seat adjustment system, a head rest adjustment system, seat belt pretensioners and/or movable upholstered elements.

When vehicle occupant protection devices are actuated to avoid the consequences of an accident in road traffic, it is possible to distinguish between preventative measures which are taken before an accident and acute measures which are taken after an accident has been detected. The invention relates to actuation of a protection device as a preventative measure, i.e., as a preventative protective measure.

German patent document DE 101 21 386 C1 has disclosed a method for actuating a reversible vehicle occupant protection device in a motor vehicle having a driving state sensor system and a reversible vehicle occupant protection device. The reversible vehicle occupant protection device can be triggered before the time of a collision and thus moved into an operative position. For this purpose the driving state data is monitored with respect to a state of emergency braking. When the state of emergency braking is detected, the vehicle occupant protection system, which comprises the vehicle occupant protection device, is actuated. In addition, oversteering and understeering are determined by a data processing device. If emergency braking, oversteering or understeering are detected by the data processing device, the reversible vehicle occupant protection system is actuated.

German patent document DE 100 47 048 A1 has disclosed a method for automatically setting the speed in a vehicle. Here, the distance and the relative speed between the vehicle and an obstacle are supplied by a sensor and used as the basis for calculating a braking torque or drive torque to be produced independently of the driver. If the distance from the vehicle drops below a minimum value, braking takes place automatically, in which case the deceleration of the vehicle follows a set point deceleration which is composed additively from three deceleration components which are detected according to different rules.

German patent document DE 197 38 690 A1 has disclosed a method for controlling the brake system of a vehicle. In addition to the values predefined by the driver, braking force is increased or decreased at the wheel brakes, with an automatic braking process being triggered when at least one signal, which represents the activation of the brake control element, exceeds at least one predefined threshold value. The at least one threshold value is changed as a function of at least one operational variable which indicates a hazard situation, the triggering of the automatic braking process becoming more sensitive as the hazard potential increases. There is provision here for the at least one operational variable to be a variable which is derived from a the distance from an obstacle which is located in front of the vehicle.

German patent document DE 101 21 956 C1 discloses a method for actuating a vehicle occupant protection system for a vehicle in which, when an obstacle is detected in front of the vehicle, a braking deceleration which is required to bring the vehicle to a stand still in front of the obstacle is determined. The determined necessary braking deceleration is compared with a maximum possible braking deceleration which is dependent on weather conditions, and a vehicle occupant protection means is activated as soon as the necessary braking deceleration has exceeded the maximum possible braking deceleration.

An object of the present invention is to make available a method for actuating a vehicle occupant protection device with which the functionality of vehicle occupant protection device is extended.

Another object of the invention is to provide a vehicle occupant protection system for carrying out the method.

These and other objects and advantages are achieved by the method and apparatus for actuating a vehicle occupant protection device according to the invention, in which the distance between the vehicle and an obstacle is sensed, braking deceleration necessary to avoid a collision with the obstacle is determined, and the determined braking deceleration is used to discover whether a predefined event has occurred. When the event occurs, the vehicle occupant protection device is actuated. The necessary braking deceleration is determined or the determined necessary braking deceleration is evaluated with respect to the occurrence of the predefined event, only if a driver of the vehicle has initiated a braking operation by activating a brake control element. The actuation of the vehicle occupant protection device triggers or activates the vehicle occupant protection device for the purpose of triggering, i.e., places the vehicle occupant protection device in a trigged state. Triggering the vehicle occupant protection device places it in an operative state in which it protects the vehicle occupants, i.e., reduces the loading on the vehicle occupants in the case of a collision.

The necessary braking deceleration can be sensed by sensing the distance from an object or obstacle and by sensing the absolute speed of the vehicle. This is advantageous, in particular, in the case of a stationary obstacle. Alternatively or additionally, the change in the distance of the vehicle from the obstacle or object, such as another vehicle traveling in front of the vehicle, or the relative speed from the object can be determined therefrom. The braking deceleration which is necessary to avoid a collision can be determined therefrom.

The braking deceleration may be determined in such a way that the vehicle would come to a standstill at a safety distance of, for example, 0.5 m from the obstacle if the physical peripheral conditions, for example a dry road, permitted. The advantage of the method comes into play in particular if the physical peripheral conditions do not allow the vehicle to be braked in such a way that a collision is prevented. This may be the case in particular on a wet road or on a road which is slippery due to snow or ice. In such cases it is nevertheless possible for a collision to occur even though sufficient braking deceleration has been determined. Furthermore, a collision may occur even if there are control interventions by the driver who attempts to avoid an obstacle and inadvertently heads for another obstacle while making the avoidance maneuver.

The predefined event may be determined to have occurred if it is no longer possible to avoid a collision with the obstacle owing to the necessary braking deceleration. The vehicle occupant protection device is thus actuated if the result of the determined necessary braking deceleration is that a collision can no longer be prevented. If, for example, another vehicle unexpectedly intersects the direction of travel, it may no longer be possible to bring the vehicle to a standstill in order to prevent a collision. This can be determined by reference to the detected distance from the obstacle and with the knowledge of the maximum possible braking deceleration of the vehicle.

In order to nevertheless protect the vehicle occupants in the event of an imminent collision, in such a case the vehicle occupant protection device can be actuated. A reversible vehicle occupant protection device is a device whose purpose is to reduce the load on a vehicle occupant in the case of a collision. It is possible to place the protection device repeatedly in an operative state from the initial state, and to return the device to its initial state from the operative state. An electric seat adjustment device and/or an electric adjustment device for vehicle openings and/or a reversible seatbelt pretensioner and/or an electrically adjustable impact protection device can be provided as vehicle occupant protection device. An electric seat adjustment device and electric adjustment devices for vehicle openings, such as the electrically adjustable sun roof and electrically adjustable window lifter, are present at least in certain cases in contemporary vehicles and can also be utilized to precondition the vehicle occupants or the vehicle at low cost.

All the electrically adjustable vehicle occupant protection devices have the advantage that the energy supply via the on-board electrical system is simple in design. In particular, electro-motor drives make it possible to reverse the vehicle occupant protection devices easily. As a result it is possible to trigger the protection devices, while taking into account their effect on a driver and other vehicle occupants, even if a hazardous situation is determined which does not have a high probability of leading to a collision but rather only a certain predefinable probability of leading to a collision.

In one refinement of the method, it is possible to provide that the predefined event is determined to have occurred if the necessary braking deceleration is above a first threshold value. The vehicle occupant protection means is thus actuated if the necessary braking deceleration is above the predefined first threshold value. This threshold value of the necessary braking deceleration is an indication of how probable a collision is. If a very high necessary braking deceleration, for example, greater than 0.7 G (braking deceleration expressed as a multiple of G, the acceleration due to gravity) is correspondingly determined, this is an indication that a collision could occur. The situation can therefore be defined as an event at which the vehicle occupant protection device is actuated in order to place it in an operative state.

In another exemplary embodiment of the method, it is possible to provide for the braking deceleration which is initiated by a driver to be determined and compared with the determined necessary braking deceleration. The vehicle occupant protection device may be actuated or activated if the difference between the braking decelerations is above a predefined second threshold value. If, for example, it is determined that the braking deceleration initiated by the driver is 0.2 G and the necessary braking deceleration to bring the vehicle to a standstill at a distance from an obstacle is 0.8 G, the difference between the braking decelerations is 0.6 G. If a second threshold value of, for example, 0.4 G is predefined for the difference, the vehicle occupant protection device is actuated since a collision is to be feared if the driver does not increase the braking deceleration. Exceeding the difference can be defined as a further event during which the vehicle occupant protection device is actuated.

In another exemplary embodiment of the method, it is possible to provide for the braking force or the braking pressure to be increased automatically for target braking, if the difference between the braking decelerations exceeds the second threshold value. Target braking is understood here to be braking at a predefined distance from the object, i.e., the vehicle comes to a standstill at a distance from a stationary object or a distance from a slower object, moving in the same direction does not become shorter than a certain value.

If the necessary braking deceleration is determined only when the driver activates a brake control, the method does not operate autonomously but rather only when the brake control is activated. As a result, the driver is not surprised or disturbed by the activation of the vehicle occupant protection device. This measure increases the protection of the vehicle. If the necessary braking deceleration is not calculated, it is also not possible to detect an event which is dependent thereon and no preventative protective measures can be initiated.

The necessary braking deceleration may be determined at the start of braking. As a result, at the start of braking it is already possible to determine whether the braking deceleration value which has been set by the driver is sufficient to brake the vehicle without a collision. If not, the one or more vehicle occupant protection device(s) can already be activated by way of precaution. This ensures that the vehicle occupant protection device is actuated in good time. In particular, preventative protection measures can be taken if a braking assistant, i.e., automatic braking to boost the braking initiated by the driver, has not been triggered. Nevertheless, there is a critical driving state owing to the rapid approach of an object. A braking assistant is triggered, for example, if a brake control speed exceeds a predefined threshold value. This means that the function of the braking assistant and the actuation of the vehicle occupant protection device can be decoupled.

In an exemplary embodiment of the method, it is possible to provide that a braking force, which is necessary for target braking, is produced at the same time as the actuation of the vehicle occupant protection device and the wheels are correspondingly braked. This measure decelerates the vehicle to an optimum degree. If the distance from the obstacle is not sufficient to prevent a collision, the collision is at least attenuated by increasing the braking pressure or by applying a braking pressure if the driver does not brake automatically. If, on the other hand, it is detected that the braking deceleration which is initiated by the driver is not sufficient, the braking force or the braking pressure is adjusted in such a way that target braking can be carried out if the physical peripheral conditions permit it. If the physical peripheral conditions do not permit it, the driver or the other occupants are nevertheless protected to an optimum degree since the vehicle occupant protection device is actuated at the same time.

In one alternative method variant, it is possible to provide that different threshold values are predefined for the actuation of the vehicle occupant protection device and the application of the braking force which is necessary for target braking. It is thus possible, for example, for the vehicle occupant protection device to already be actuated when the braking assistant has not yet adjusted the braking deceleration for target braking since the driver possibly still has sufficient time to increase the braking force or the braking pressure himself in order to avoid a collision.

The vehicle occupant protection device is advantageously deactivated when an abort condition occurs. If a critical situation is no longer present, the vehicle occupant protection device can also be deactivated. An abort condition can be present, for example, if the driver continues to activate the accelerator pedal or activates it again. Furthermore, an abort condition may be if the brake is released again by the driver. Furthermore, the vehicle occupant protection device can be deactivated again if the vehicle is stationary.

An exemplary embodiment of the present invention includes a vehicle occupant protection system having a vehicle occupant protection device which is activated by a control device, in particular in order to carry out the abovementioned method. Here, an environment sensor system is provided which comprises distance sensors for determining the distance of the vehicle from an obstacle and a device for determining the relative speed with respect to the obstacle being provided. The control device has a braking deceleration determining direction which determines the necessary braking deceleration to avoid a collision from the distance and the relative speed. In vehicle occupant protection systems which are known from the prior art, the vehicle occupant protection device are actuated if a particular vehicle state, such as a particular vehicle movement dynamics state, applies or if the braking assistant is activated due to the detection of a driver's braking request. By contrast, the vehicle occupant protection device of the vehicle occupant protection system according to an exemplary embodiment of the present invention is activated as a function of an environment sensor system. This measure allows the vehicle occupant protection device to be actuated or activated at an earlier time. Owing to the environment sensor system, it is possible to detect a hazardous situation even if the driver has not yet realized this himself, and the vehicle occupant protection device can be activated accordingly.

The activation can also be improved if, in addition, a driving state sensor system is provided. In particular, the longitudinal speed of the vehicle can be sensed by the driving state sensor system and taken into account in determining the necessary braking deceleration.

Other objects, advantages and novel features of the present invention will become apparent from the following detailed description of the invention when considered in conjunction with the accompanying drawings.

### BRIEF DESCRIPTION OF THE DRAWING FIGURES

The FIGURE shows a schematic illustration of a vehicle occupant protection system.

### DETAILED DESCRIPTION OF THE DRAWINGS

In the FIGURE, a vehicle occupant protection system 1 is illustrated in a schematic fashion. The vehicle occupant protection system has a vehicle occupant protection device 2 which is activated if a collision is to be feared. The vehicle occupant protection device is activated or actuated by a control device 3. The control device 3 can detect an event during which the vehicle occupant detection device 2 has to be activated. An environment sensor system 4 which comprises distance sensors 5 can detect distances from objects in the surroundings of a vehicle.

Furthermore, relative speeds of the vehicle in which the vehicle occupant protection system 1 is installed can be determined with respect to a detected object by device 6a for determining the relative speed. The environment sensor system 4 is connected to a braking deceleration determining device 6 of the control device 3. In the braking deceleration determining device 6, the necessary braking deceleration to brake a vehicle in such a way that a collision does not occur with an object sensed by the surroundings sensor system 4 is determined. In this context it is possible to provide that in the case of a stationary object the braking deceleration is determined in such a way that the vehicle comes to a standstill before the object. If the object is a moving object, the braking deceleration can be determined in such a way that the vehicle is braked to a predefined distance from the object.

Furthermore, a driving state sensor system 7 can be provided which is connected, for example, to a wheel speed sensor 8. The vehicle speed can be determined from the signals of the sensor 8. The speed can be taken into account in determining the braking deceleration or in the actuation of the vehicle occupant protection device 2. The control device 3 can furthermore be connected to a brake system 9 which can be actuated by a brake assistance system. In particular, it is possible to provide that a brake pressure is applied automatically to the brake system 9 if it is detected that the braking deceleration which is determined by the braking deceleration determining device 6 is significantly higher than the braking deceleration which is applied by a driver by a brake control 10.

The control device 3 can comprise a comparison device 11 in which the determined necessary braking deceleration is compared with the braking deceleration applied by the driver. If a deviation occurs which exceeds a predefined threshold value, it is possible to provide that both the vehicle occupant protection device 2 and the brake system 9 are actuated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A method for actuating a vehicle occupant protection device in a vehicle, comprising:
sensing a distance from an obstacle to the vehicle;
determining a braking deceleration which is necessary to avoid a collision with the obstacle;
determining whether a predefined event has occurred, based on the determined necessary braking deceleration; and
actuating the vehicle occupant protection device when the predefined event occurs;
wherein activation of a brake control by a driver of the vehicle is a precondition for the determination of the necessary braking deceleration or for the determination of the occurrence of the predefined event.

13. The method as claimed in claim 12, wherein the predefined event has occurred if the determination of the necessary braking deceleration indicates that the collision with the obstacle can no longer be prevented.

14. The method as claimed in claim 12, wherein the predefined event has occurred if the necessary braking deceleration is above a predefined first threshold value.

15. The method as claimed in claim 12, wherein:
a braking deceleration initiated by the driver is determined and is compared with the determined necessary braking deceleration; and
the predefined event has occurred if the difference between the braking decelerations exceeds a predefined second threshold value.

16. The method as claimed in claim 15, wherein, if the difference between the braking decelerations exceeds the second threshold value:
a braking force is increased automatically for target braking; and
the vehicle is braked by the target braking in such a way that the distance from the obstacle does not drop below a predefined value.

17. The method as claimed in claim 15, wherein the necessary braking deceleration is determined at the start of braking.

18. The method as claimed in claim 12, wherein a braking force which is necessary for target braking is produced simultaneously with the actuation of the vehicle occupant protection device.

19. The method as claimed in claim 12, wherein different threshold values are predefined for actuation of the vehicle occupant protection device and for application of a braking force which is necessary for target braking.

20. The method as claimed in claim 12, wherein the vehicle occupant protection device is deactivated when an abort condition occurs.

21. The method as claimed in claim 13, wherein the predefined event has occurred if the necessary braking deceleration is above a predefined first threshold value.

22. The method as claimed in claim 13, wherein:
a braking deceleration initiated by the driver is determined and is compared with the determined necessary braking deceleration; and
the predefined event has occurred if the difference between the braking decelerations is above a predefined second threshold value.

23. The method as claimed in claim 14, wherein:
a braking deceleration initiated by the driver is determined and is compared with the determined necessary braking deceleration; and
the predefined event has occurred if the difference between the braking decelerations is above a predefined second threshold value.

24. The method as claimed in claim 16, wherein the necessary braking deceleration is determined at the start of braking.

25. The method as claimed in claim 13, wherein a braking force which is necessary for target braking is produced simultaneously with the actuation of the vehicle occupant protection device.

26. The method as claimed in claim 14, wherein a braking force which is necessary for target braking is produced simultaneously with the actuation of the vehicle occupant protection device.

27. The method as claimed in claim 15, wherein a braking force which is necessary for target braking is produced simultaneously with the actuation of the vehicle occupant protection device.

28. The method as claimed in claim 13, wherein different threshold values are predefined for actuation of the vehicle occupant protection device and for application of a braking force which is necessary for target braking.

29. The method as claimed in claim 14, wherein different threshold values are predefined for actuation of the vehicle occupant protection device and for application of a braking force which is necessary for target braking.

30. A vehicle occupant protection system in a vehicle, comprising:
a control device;
a vehicle occupant protection device which is actuated by the control device;
an environment sensor system which comprises distance sensors for sensing a distance of the vehicle from an obstacle;
a relative speed determining device for determining relative speed of the vehicle with respect to the obstacle;
a sensing device for sensing activation of a braking activation element; and
a braking deceleration determining device which determines necessary braking deceleration to avoid a collision, based on determined distance and the relative speed;
wherein the control device determines whether a predefined event has occurred, based on the determined necessary braking deceleration, and is configured to determine the necessary braking deceleration or use the determined necessary braking deceleration as a basis for actuating the vehicle occupant protection device, only if the driver has activated the brake activation element.

31. The vehicle occupant protection system as claimed in claim 30, further comprising a driving state sensing system.
